(19) United States
(12) Patent Application Publication
(10) Pub. No.: US 2011/0168282 A1
(43) Pub. Date: Jul. 14, 2011

(54) Mobile material transfer system for delivery and receiving of solid and liquid material or combinations thereof

(76) Inventor: Nickolaos Mitropoulos, Thomastown (AU)

(21) Appl. No.: 12/932,379

(22) Filed: Feb. 22, 2011

(30) Foreign Application Priority Data
Aug. 22, 2008 (AU) 2008904337
Aug. 21, 2009 (AU) PCT/AU2009/001074

(51) Int. Cl. B67D 7/02

(52) U.S. Cl. 137/565.01

(57) ABSTRACT

A material transfer unit including:
a mobile container having at least one receptacle mounted to a wheeled support frame that has top and bottom frame ends and wherein the bottom end includes a wheeled base and a first weigh cartridge location between the base and the at least one receptacle;
a controller operatively connected to the supply station;
a pump supported by the mobile container for transferring material from the at least one receptacle to a storage container;
a weigh cartridge including a weigh pan that is operably connectable to the controller, wherein the weigh cartridge is removably received within the first weigh cartridge location between the base and the receptacle, whereby the weigh pan is connected to a weigh indicator which is calibrated to determine the amount of material supplied/dispensed to/from the at least one receptacle by the supply station.

### FIELD OF THE INVENTION

The present invention relates to a portable system for use in transferring and receiving solid and/or liquid material such as cooking oil and fats and the like. In particular the present invention relates to a mobile material transfer system for supplying solid and/or liquid material to and removing waste material such as cooking oil(s) from a commercial or domestic site.

### BACKGROUND OF INVENTION

It is known in the restaurant field that very substantial quantities of fresh cooking oil need to be on hand to fry various food products such as potatoes, fish and other products. In commercial restaurants it is not unusual for a single frying vat, in which frying of food products takes place, to accommodate commercial quantities of over ten litres of cooking oil. Spent cooking oil is removed regularly and the vat or vats replenished with a fresh supply of oil.

In commercial restaurants and shops including take away fish and chip shops it is typical to maintain a continuous fresh supply of cooking oil. In commercial restaurants a supply of fresh oil is usually maintained in a holding tank on the shop premises, which can be accessible for connection to a frying vat to allow either pumping of oil or flow of oil under gravity to replenish the vat. This system usually requires purchase of a bulk oil holding tank and a tank housing from a supplier, which has the drawback of occupying a substantial amount of space otherwise occupying internal usable restaurant space, and committing the owner to future bulk oil purchasing. Even further, additional storage tanks are required to receive and hold waste oil hence salvaging of waste adds to the expense and space constriction.

Holding tanks of the type used in commercial restaurants are commonly supplied with bulk oil by a truck transport carrying a storage tank containing bulk volume of oil. Once on the premises, a truck operator may connect a hose on the storage tank to the holding tank to pump new oil into the holding tank. While this method of supplying oil has been historically satisfactory in the sense of being able to supply a quantity of fresh oil, it is a recognised problem that often the metered amount of oil dispensed is less than the amount actually dispensed. Factors affecting volume measurement include:
faulty calibration of flow measuring devices;
fluctuations in temperature, wind forces, rainfall, and liquid density;
random errors, due to human faults; movement of oil or the like.

As a result a restaurant owner is frequently paying for a particular quota of oil and receiving a lesser amount. There is thus a need to provide a supply means, which minimises the effect of the above factors.

Further, it is not uncommon for restaurants and fast food outlets to employ solid fat materials as a cooking/frying medium or indeed a composition comprising a mixture of solid fats and liquid oils. The conventional supply means does not allow for transfer of liquefied solids including fats or combinations.

In smaller to medium sized restaurants or take-away businesses it is not uncommon for personal to manually add new cooking oil from containers into the frying vat. This means of replenishing a frying vat with cooking oil exposes personal to substantial inconvenience not to mention risks of spillage and injury.

It is therefore an object of the present invention to address one or more of the disadvantages of the prior art delivery systems or at least to provide a delivery system, which can provide the public with a useful alternative.

### SUMMARY OF THE INVENTION

In accordance with the invention there is provided a material transfer unit moveable between a supply station and a material storage tank or cooking vat including:
at least one mobile container, the container having an internal compartment for receiving a quantity of material or mixture of materials from the supply station,
a controller operatively connected to the supply station,
a pump means supported by the container for transferring material from the internal compartment to a vat or other storage or packaging means,
a weigh cartridge including a weigh pan, the weigh pan being operably connectable to the controller,
at least one mounting portion adjacent to or on the container for removably receiving the weigh cartridge, whereby the weigh pan is connected to a weigh indicator which is calibrated to determine the amount of material transferred from or received by the container, and
wherein upon receiving or transferring of material, the change in weight of the container is measured by the weigh pan and the actual amount of material transferred is determined by the weigh indicator on a weight differential calibration.

The portable transport unit provides a substantial advance over the prior art systems of supplying fresh cooking oil to restaurants, take-away foods businesses and the like fast food shops. For example, the present invention does not require a restaurant owner to purchase a storage tank for holding large quantities of oil. Hence there is an immediate cost saving as well as ongoing savings by not having committed to bulk purchases of fresh oil. The present invention enables a supply directly to a kitchen apparatus such as a frying vat. Even if a restaurant owner has already purchased a storage tank, the present invention can be used to transfer any desired volume into an existing tank.

Without the need for a storage tank there is also a space saving, that is, more available space for commercial improvements. There is also a time saving in that transfer of fresh oil can be made directly to a frying vat without the need to first fill a storage tank from a supply tanker and then pump from the storage tank to a frying vat. The system according to the invention further provides an improved quantitative measure of material transfer since it is not as affected as are conventional methods by exposure environmental factors such as temperature, humidity and density.

The at least one mobile container can include a heating element within the internal compartment, which can be used to maintain a supply of a cooking fat, otherwise solid at ambient temperature, in a liquefied state. This represents an advance over prior art systems because until now solid cooking fats could only be supplied in bulk prepacked drums, which occupy space but also require removal therefrom into a cooking vat plus subsequent application of heat.

The at least one mounting portion of the unit can be located beneath the internal compartment of the container so that when the weigh cartridge is mounted, the container is seated on or adjacent to the weigh pan.

In a further embodiment, the at least one mounting portion of the unit can be located above the internal compartment for removably mounting the weigh cartridge in a second mounting condition adjacent to or seated on the mobile container.

In this second mounting condition, the unit can receive an existing storage container or packaging vessel on top of the first container and allow positive engagement between the weigh pan and the storage container or packaging vessel and in turn allow transfer of material between the mobile container and packaging vessel or storage container, and measurement of material weight transfer to or from the storage container or packaging. In a further embodiment, the unit can include a first and second mounting portion located beneath and above the internal compartment respectively so that the weigh cartridge can be relocated from one mounting portion to the other

The pump means can include a removable tap interconnected thereto so that cooking material drawn from the internal compartment under vacuum can be directed by the tap to another vessel or directly into a kitchen apparatus such as a fryer.

The mobile unit can include a vacuum pump mounted by the mobile container, and a material transfer pipe extendable between a frying vat and the internal compartment for transfer of waste from the frying vat, whereby in operation the vacuum pump creates a vacuum in the air space of the internal compartment of the mobile container wherein the vacuum allows transfer of contents from the vat to the container as waste via the transfer pipe. In this embodiment, the weigh cartridge is located on the unit in a mounting portion located beneath the internal compartment so that the change in weight of the waste material and mobile container is determined by the weigh pan.

In one embodiment the transportable unit can include a mobile container for receiving waste material from a waste vessel or frying vat, and a pre-packaged container stacked on the mobile container, wherein the pre-packaged container can contain a fresh supply of a material or mixture of materials from the supply station such that when waste material is returned under vacuum from a vat or fryer to the first container, the second container can subsequently supply a fresh amount of material or mixture of materials directly to the vat/fryer to replenish the cooking medium. In both cases, the weigh cartridge can be relocated so as to measure the amount of waste material returned to the first container and measure the amount of material transferred from the second container to the vat/fryer or storage tank.

The mobile container can further include an inlet port adapted to fit a filter element and a washing element. The filter element can include an oil filter through which cooking material oils and/or fats pass, and a connector(s) for interconnection to the vacuum pump. The washing element can include a hollow body on the end of which there is mounted a spray head wherein when fitted to the inlet port the body and spray head reside within the internal compartment of the mobile container wherein the body and spray head are in fluid communication and the body is connectable to an external fluid source.

The controller can be programmed to operate the supply station such that the supply station can supply a preselected material or mixture of materials including cooking oils and/or fats

The weigh cartridge can further include a lifting means such as air-operated cylinders to assist lifting the unit or the at least one mobile container. The weigh cartridge can include an air operated hydraulic ram or rams which operably urge positive engagement between the weigh pan and the container so that the container and/or whole unit can be weighed and weigh measurements of material transferred from or received by the container determined. An advantage of the air ram(s) is that the container can be lifted from the weigh pan while the unit is mobile—and the weigh pan can positively engage the container in a stationary position.

The mobile container can include a further compartment adjacent the internal compartment for housing a vacuum pump and/or compressed air cylinder.

The mobile container can include a wheeled support frame. The support frame can include a top and bottom frame ends wherein the bottom end includes a wheeled base and recess for removably receiving the weigh cartridge. The support frame can also include a recess in the top frame end to removably receive the weigh cartridge in a second weigh condition such that a second container can be located above the first container in a stackable array and seated on the weigh cartridge.

The top and bottom recesses in the wheeled support frame enable stacking of containers substantially on top of each other. The weigh cartridge can be removably located in a first of the recesses to receive a first container in a weighing condition such that the weight of the first and subsequent containers can be continuously monitored.

In a related aspect of the invention there is described a method of transferring a supply of a selected cooking oil or blends of cooking oils and/or cooking fats, the process including:
providing a material transfer unit moveable between a supply station and a material storage tank or cooking vat and the like, the unit including:
   a mobile container, the container having an internal compartment for receiving a quantity of material or mixture of materials from the supply station,
   a controller operatively connected to the supply station for,
   a pump means supported by the container for transferring material from the internal compartment to a vat or other storage or packaging means,
   a weigh cartridge including a weigh pan, the weigh pan being operably connectable to the controller, whereby the weigh pan is connected to a weigh indicator which is calibrated to determine the amount of material transferred from or received by the container;
   a mounting portion located beneath the internal compartment of the container for removably engaging the weigh cartridge in a first mounting position below the container;
   a lifting means mounted by the weigh cartridge the lifting means being operable to urge positive engagement of the weigh pan with the container thereabove so that the container and/or whole unit can be lifted and weighed;
      including the steps of transporting the mobile container to a kitchen apparatus such as a frying vessel or storage vessel, actuating the lifting means so that the weigh pan is positively urged against the mobile container, actuating the pump means to transfer a supply of material from the mobile container to the storage vessel or fryer or the like, wherein upon transferring the material, the change in weight of the container is measured by the weigh pan and the actual amount of material transferred is determined by the weigh indicator on a weight differential calibration.

The mobile unit of the present invention allows easy transfer of a fresh supply of material or mixture of materials to an existing storage tank or directly to a kitchen apparatus such as a fryer.

In a further related embodiment of the invention there is described a process for packaging a supply of oil, the process including:
providing a material transfer unit moveable between a supply station and a material storage tank or cooking vat and the like, the unit including:
   a container adapted to be transportable, the container having an internal compartment for receiving a quantity of material or mixture of materials from the supply station,
   a controller operatively connected to the supply station for controlling a supply of a material or mixture of materials from the supply station to the container,
   a pump means supported by the internal compartment of the container for transferring material from the internal compartment to a packaging container,
   a weigh cartridge including a weigh pan, the weigh pan being operably connectable to the controller, whereby the weigh pan is connected to a weigh indicator which is calibrated to determine the amount of material transferred from or received by the container;
   a lifting means mounted by the weigh cartridge, the lifting means being operable to urge positive engagement between the weigh pan and the packaging container so that the packaging container can be lifted and weighed;
   a mounting portion located above the internal compartment of the mobile container for removably engaging the weigh cartridge in a first mounting position above the mobile container;
wherein a packaging container is placed on the weigh cartridge and the weigh pan is positively urged against the mobile container, and wherein the pump means transfers a supply of material from the mobile container to the packaging container, and the change in weight of the packaging container is measured by the weigh pan and the actual amount of material transferred is determined by the weigh indicator on a weight differential calibration.

An advantage of the present invention is that it can be used to pre-pack a desired cooking material or mixture at the supply station, and thereafter the transportable unit can deliver the pre-packaged material to a restaurant or kitchen. Alternatively, the mobile unit can be transported to an existing storage vessel wherein the mobile container can be positioned below the storage vessel and the weigh pan subsequently urged by the lifting means into positive engagement with the storage vessel.

A further advantage is that packaging can be conducted remotely and in a controlled environment so as to minimise exposure to external factors such as humidity, temperature and the like.

In this embodiment, the unit can further include a packaging container receptacle mounted on the weigh pan for receiving the packaging container or a storage vessel. The packaging or container receptacle can include a series of annular internal shoulders spaced in stepped apart relation for receiving containers or packaging vessels of varying sizes.

Alternatively the container receiving structure can comprise a series of discrete stackable bodies for receiving containers of varying sizes wherein said stackable bodies include a seat for receiving a base portion of a corresponding sized container and a shoulder for receiving the seat of a second mounting body in a demountable stackable array.

Preferably the stackable bodies forming the container receptacle structure include co-operating mounting means so that a plurality of bodies can be readily stacked or separated from one another.

In one embodiment of the present invention the combination portable material transfer unit and packing case can be used in a packaging process. Alternatively the packing base can be added to the portable unit in a waste receiving operation whereby waste oil can be pumped into a container onsite and the volume of waste oil transferred calculated by the second weigh pan.

In a further related aspect of the invention there is provided a material transfer system which is portable for receiving or transferring a measurable quantity of a solid and liquid material or combinations thereof such as cooking oil and fats, the system including:
a mobile supply station having one or more vessels for supply or receiving an amount of a material or mixture of material, the one or more vessels being interconnected to a pumping means to transfer a material or mixtures of materials, the pumping means being operable by a controller to provide a measured amount of material or mixture of materials from the one or more vessels; and
a transportable material transfer unit moveable between the supply station and a material storage tank or cooking vat including:
at least one mobile container, the container having an internal compartment for receiving a quantity of material or mixture of materials from the supply station,
a controller operatively connected to the supply station,
a pump means supported by the container for transferring material from the internal compartment to a vat or other storage or packaging means,
a weigh cartridge including a weigh pan, the weigh pan being operably connectable to the controller,
at least one mounting portion adjacent to or on the mobile container for removably receiving the weigh cartridge, whereby the weigh pan is connected to a weigh indicator which is calibrated to determine the amount of material transferred from or received by the container, wherein upon receiving or transferring of material or combinations of material, the change in weight of the container is measured by the weigh pan and the actual amount of material transferred is determined by the weigh indicator on a weight differential calibration.

In the present system the term ‘material’ can include conventional cooking oils and fats in liquefied form. An even further advantage of the present system is that mixtures of cooking oils and fats can be readily provided on site. For example, where a restaurant or fast food outlet requires a composition of oils and/or fats, the desired composition can be formulated on site.

The system of the invention can include a blending station intermediate the supply station and the transportable material transfer unit, wherein the one or more vessels is/are separately interconnected to the blending station by a series of pump means, and wherein the controller controls the series of pump means to provide a desired material or combination of materials to the transfer unit. In contrast to conventional systems, the instant system can provide a supply of any cooking medium including oils or fats and combinations thereof directly to a mobile transfer unit, cooking vat or existing storage facility.

In this embodiment of the invention, the blending station can be located above the level of the mobile container so that material at the blending station can be fed to the container by gravity feed. In a further embodiment, the blending station can include a series of inlet ports so that each vessel at the supply station can be provided with a dedicated pump line to a separate inlet port. In this embodiment the blending station is a common vessel, and the use of dedicated pump lines substantially avoids any possibility of cross contamination of different materials.

One or more of the vessels at the supply station can include a heating element so that a supply of a cooking fat or fats can be maintained at a temperature so as to provide the fat or fats in a liquefied form.

The weigh cartridge can further include a lifting means such as air-operated cylinders to assist lifting a mobile container.

In related aspect of the present invention there is disclosed a method of transferring cooking oils or fats or combinations thereof to or from a restaurant or take-away food business including the steps of:
providing a material transfer system which is portable for receiving or transferring a measurable quantity of a solid and liquid material or combinations thereof including:
   a material transfer unit moveable between a supply station and a material storage tank or cooking vat, the unit including:
      at least one mobile container having an internal compartment for receiving a quantity of material or mixture of materials from the supply station,
      a controller operatively connected to the supply station,
      a pump means supported by the container for transferring material from the internal compartment to a vat or other storage means,
      a first mounting portion located beneath the internal compartment;
      a weigh cartridge including a weigh pan, the weigh cartridge being operably connectable to the controller and removably mounted by the first mounting portion such that in an operating condition the container is seated on the cartridge, wherein the weigh pan is connected to a weigh indicator which is calibrated to determine the amount of material transferred from the container,
      wherein upon receiving or transferring of material, the change in weight of the container is measured by the weigh pan and the actual amount of material transferred is determined by the weigh indicator on a weight differential calibration; and
         actuating the pump means to transfer a volume of material from the container to a frying vat or storage tank and calculating the volume by (a) transferring weight data from the weigh pan to the weigh indicator and (b) programming the weigh indicator to calculate volume based on weight differential and material density.

The weigh indicator can include control software which is designed to manipulate data input to provide output information relating to volume of oil transferred, quality and type of oil transferred, cost of oil and other business related information. The information can be formatted to meet general auditing and business standard practice. The weight data and weight calculations can be transmitted to a remote site for review. Hence the control software can be used for providing information and invoices. The controller can be an electronic wireless controller which received data from the weigh pan or weigh cell. The controller can include a wireless data transfer facility, and can be connected to a personal computer with an inbuilt scanner with a signal to operate.

The material transfer system can include a pre-mixing station wherein the pre-mixing station is provided with (i) storage means for separately storing two or more different oils for cooking, and (ii) an oil distribution means interconnected to the storage means, wherein the distribution means meters out a predetermined volume of an oil or selection of two or more oils.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1: shows a perspective view of a portable transfer unit in accordance with one embodiment of the present invention;

FIG. 2: shows an alternative perspective view of the portable unit in accordance with FIG. 1;

FIG. 3: shows a perspective view of the portable unit in accordance with a further embodiment of the present invention;

FIG. 4A: shows a perspective view of the portable unit with a packing base in accordance with an embodiment of the present invention;

FIG. 4B: shows a cross sectional schematic representation of the embodiment shown in FIG. 4A;

FIG. 5: shows a schematic representation of the portable unit according to FIGS. 4A and 4B in a packaging process;

FIGS. 6A and 6B: show cross-sectional schematic representations of yet a further embodiment of the portable unit according to the present invention;

FIG. 7: shows a schematic representation in a perspective view of a material transfer unit in accordance with the present invention;

FIGS. 8a and 8b: show a schematic representation in perspective view of a further embodiment of the material transfer unit in accordance with FIG. 7

FIG. 9: shows a schematic representation in perspective view of a further embodiment of the material transfer unit according to FIG. 7 when used for transferring material to an existing storage facility

FIGS. 10a and 10b: show schematic representations in perspective view of a further embodiment of the material transfer unit in accordance with the present invention used for collecting waste material and replenishing supply from a pre-packaged container

FIGS. 11a, 11b and 11c: show cross-sectional schematic representation of various components for use in the material transfer unit according to FIG. 7;

FIGS. 12a and 12b: show an elevation view and perspective view of a weigh cartridge used in the present invention;

FIG. 13: is a schematic representation in a perspective view of a further embodiment of the portable unit according to the present invention showing multiple stations and vacuum means for a container.

### DETAILED DESCRIPTION OF THE PREFERRED EMBODIMENTS WITH RESPECT TO THE ACCOMPANYING DRAWINGS

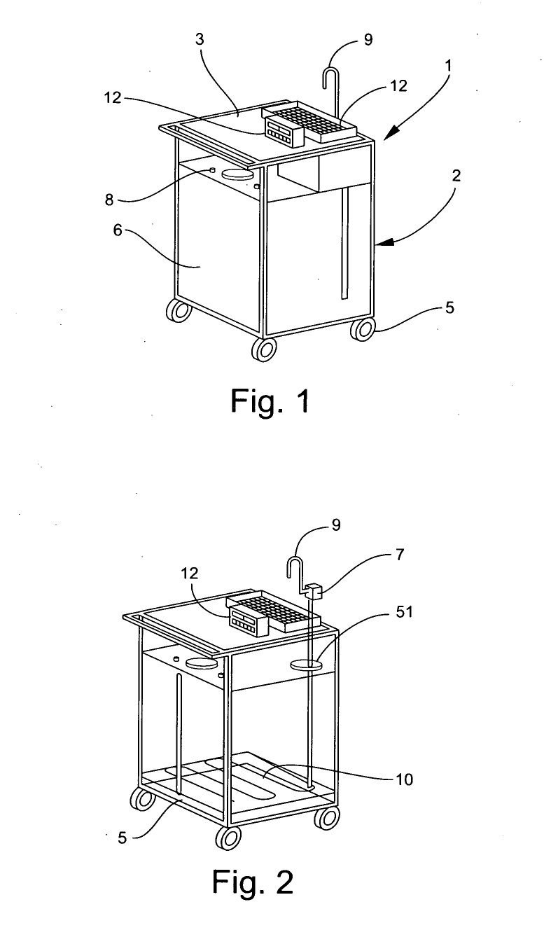

Referring to FIGS. 1 to 3 there is shown a material transfer unit 1, which is portable, for transferring a quantity of a material such as cooking oil or a solid cooking fat in liquefied form or combinations thereof to a restaurant or take-away food business or the like (not shown).

The transfer unit comprises a mobile container 6, which is mobile, made from stainless steel or plastic. In this embodiment the container has a volume capacity of about 80 litres and is shown having a wheeled base 5 so that the unit can be readily moved between a supply station (not shown) and a frying vat or storage tank. The unit also includes a frame structure 2 being supported by the wheeled base, the unit having a planar top 3 mounted on a top portion of the frame.

The unit 1 further includes a controller 12 operatively connected to a pump means 7 and a supply station (not shown). The pump means is supported by the container 6 in a sealed condition 6 by a clamping device 51, and is adapted for transferring material from the container to a vat or other storage means.

The container 6 may also include a breathing opening 8 to allow a return to equilibrium pressure between environment and container once a quota of material has been transferred. The pump means ends in a tap structure 9 for directing dispensing of container contents.

The container may include a liquid level indicator 14 as a visual guide to assist estimate of material contents in the container. As shown in FIG. 1, the unit 1 further includes a heating element 10 which is housed within the container and connectable to an external power source. The heating element allows delivery and transfer of material such as cooking fats which are generally solid at ambient temperatures.

As best seen in FIG. 2, the unit 1 further includes a weigh cartridge 11 removably mounted to the wheeled frame 5 immediately below the container 6 in a first mounting condition. In this embodiment, the container is seated directly on the weigh cartridge.

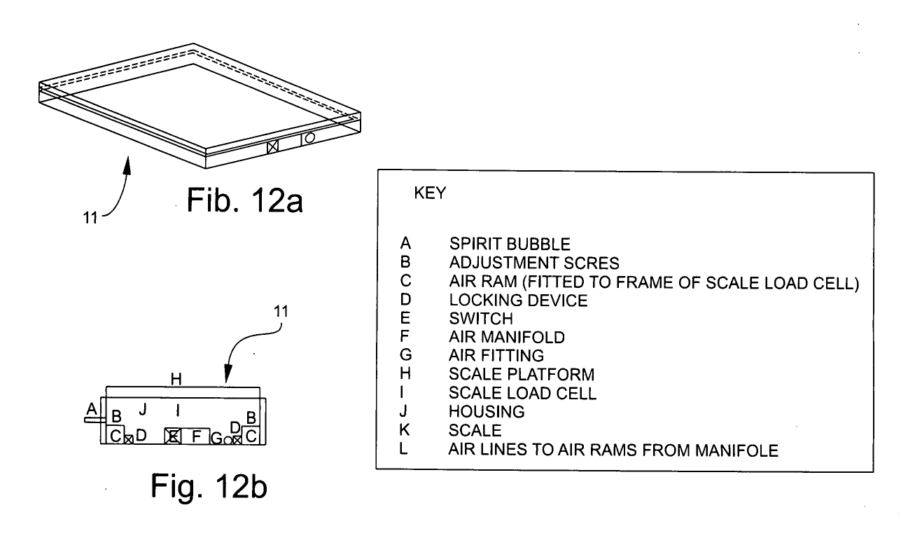

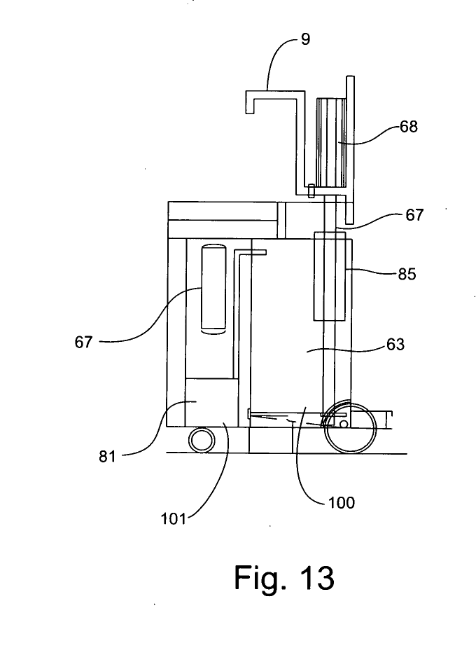

The weigh cartridge includes a weigh pan (best seen in FIG. 12) and is operably connected to the controller 12. The weigh pan in turn is connected to a weigh indicator, which is calibrated to determine the amount of material transferred from the container. The weigh indicator includes control software, which is designed to manipulate data input to provide output information relating to volume of oil transferred, quality and type of oil transferred, cost of oil and other business related information.

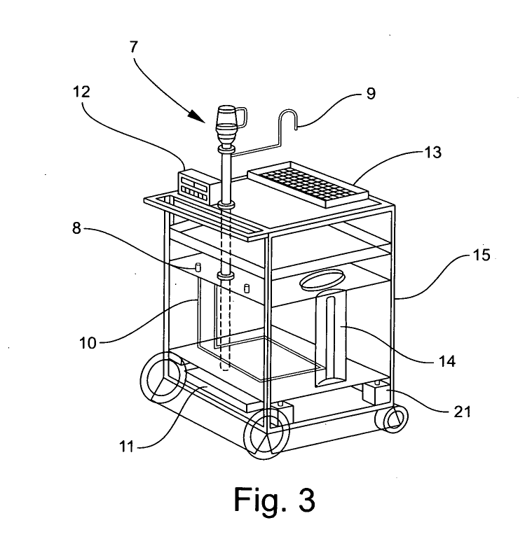

As best shown in FIG. 3 the weigh pan 11, having an integrated load cell, is mounted in a first weighing position, to the wheeled base 5. The top part 3 of the frame provides a support surface for receiving the controller 12 being a wireless digital display device and a drip tray 13. The wireless digital display device is calibrated to receive input data from the weigh pan and determines the volume of material transfer based on weight differential and material density calculations. In this way the error tolerances for determining volume of material transferred is substantially reduced hence concomitantly greater accuracy is achieved

The weigh cartridge 11 of the mobile unit includes a air-operated hydraulic rams 21, which operate on compressed air, to assist lifting of the mobile unit or the weigh pan into engagement with the container 6 to allow weight measurement.

As seen in FIG. 3 the top portion of the frame can be adapted to be slidably received on the frame hence the top portion can be removed to allow easy access to the container for removal and replacement with a fresh or empty container for transfer of fresh oil and receiving of old oil respectively. Additionally the hydraulic rams 21 located on the bottom end of the frame adjacent the wheeled base can be used to raise or lower a full or partially full container relative to the frame.

In operation (refer FIG. 3 for example), the mobile container with material contents is initially weighed by the weigh pan, and the final weight measured following transfer of material. The weight data at both the start of transfer and end is sent to the digital display device 12. The volume of material transferred or indeed received is calculated and cost to a restaurant or take-away food operator is determined.

In a further embodiment, the invention provides a material transfer system, which is mobile for receiving and/or transferring a measurable quantity of a solid and liquid material or combinations thereof such as cooking oil and fats. The mobile system includes the material transfer unit 6 and a mobile supply station (not shown). The supply station is provided with (i) a mobile storage facility for separately storing one or more different cooking oils or liquefied fats, and (ii) a blending facility such that one or more of the oils and/or fats or mixtures thereof can be selected and metered out into one or more mobile transfer units 6.

The supply station may therefore have one or more vessels for supply or receiving an amount of a material or mixture of material, the one or more of the vessels being interconnected to a pumping means (not shown). The pumping means being operable by a controller to provide an amount of material or mixture of materials from the one or more supply vessels. In one embodiment the mobile supply station includes one or more vessels for receiving transfer of waste oil/fats.

The unit 1 can further include a vacuum pump (see FIG. 10b), and an oil transfer pipe. In an operating condition, the vacuum pump creates a vacuum in the air space of the container, and the transfer pipe extends between the container and a cooking vat or waste storage vessel (not shown), wherein the vacuum created in the container urges transfer of waste oil from the vat/fryer to the waste container via the pipe.

Once waste oil material has been returned to the unit container 7, the further container can supply a fresh amount of material or mixture of materials directly to the vat/fryer to replenish the cooking medium. In this embodiment it can be seen that the weigh cartridge 12 has been securely relocated to the second mounting position on unit container 6. In this position the further container can be located securely on top of the unit container and seated directly on the weigh cartridge so that (i) the amount of waste material returned to the unit container can be determined, and (ii) the amount of material transferred from the further container to the vat/fryer or storage tank is also determined.

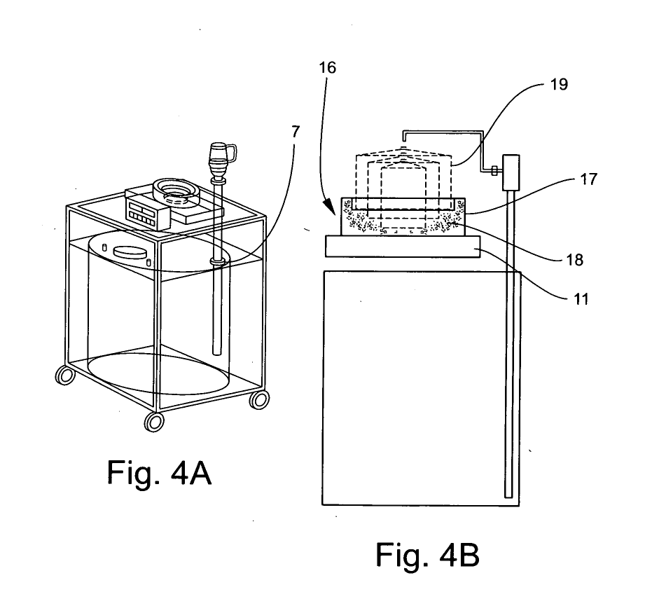

Referring to FIGS. 4A and 4B there is shown a further embodiment of the invention in which the portable transfer unit includes a packing base 16 mounted to the top support of the frame. The packing base includes a container receiving structure 17 having a series of internal shoulders 18 in stepped apart relation for receiving containers 19 of varying sizes. In this embodiment the container receiving structure comprises a generally circular geometry with three annular shoulders which are spaced in stepped apart relation as shown in cross section to receive containers of three different sizes.

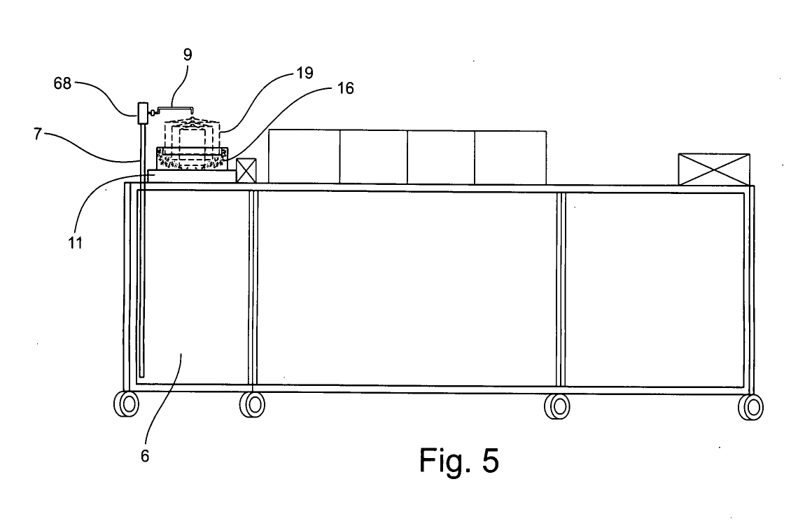

The packing base further includes the weigh cartridge 11 on which the container receiving structure is mounted. The packing base can be used in a packaging process line as can be seen from FIG. 5 where containers of varying sizes can be filled with fresh oil at a decentralized site, packed and stored ready for use. Alternatively the packing base can be added to the portable unit in a waste receiving operation to receive waste oil onsite and calculating the volume of waste oil transferred.

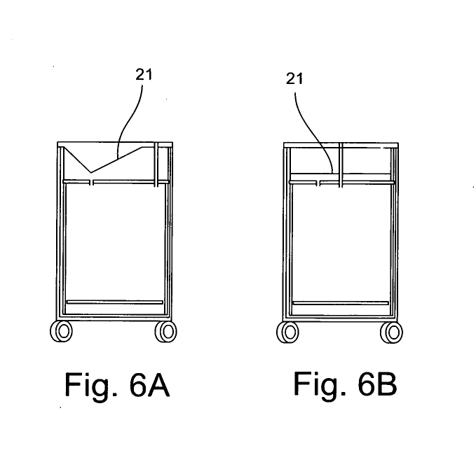

Referring to FIGS. 6A and 6B there is shown a portable material transfer unit for salvaging old oil. In this case the portable unit includes a sieve structure 21 disposed between the container and a pump outlet (not shown). The sieve receives liquid waste oil from a pump means and provides a filtering pathway such that liquid waste oil entering the sieve is directed over a membrane or other structure to substantially remove solid particulate matter before entering the container. Removal of solid particulate matter is an advantage when salvaging oil since a restaurant or take-away food operator may receive a salvage payment based on amount of non-contaminated oil which has been collected.

In yet a further embodiment of the present invention there is disclosed a method of transferring fresh cooking oil to a restaurant or take-away food business. The method requires providing a portable cooking oil transfer unit as hereinbefore described. The portable unit comprises a wheeled frame able to be transported to a site with a frying vat or storage tank. A container of the type shown in FIGS. 1 to 3, which has been filled at a remote packing site, may be inserted within the wheeled frame and seated upon a weigh pan located at a base portion of the bottom end of the frame. The container is connected to a pump device supported by a top frame end portion. The top frame portion carries a weigh indicator adapted to wirelessly receive weight input data from the weigh pan. An initial weight measurement is recorded by the weigh pan and transmitted to the weigh indicator. The pump is actuated so that material within the container is transferred directly into a frying vat or other storage means. A final weight of the container is measured and transmitted to the weigh indicator. The weigh indicator is programmed to calculate the volume of material transfer based on weight measurements received and other physical parameters such as density. When the oil has been transferred, the container is removed from the wheeled frame and a second filled container inserted. The process of transferring oil can be repeated by continually replacing exhausted containers with a fresh container.

When the present portable unit is used for transfer of waste cooking oil for example, the unit includes a packing base member 16 mounted to a top frame end of the wheeled frame. The packing base includes a container receiving structure and a second weigh pan beneath the container receiving structure. An empty container is placed within the container receiving structure and the wheeled frame positioned at the site to receive waste oil directly from a frying vat or other waste storage means. Waste oil is transferred by gravity or pump means into the container. The container is weighed by the second weigh pan initially in an empty state and the weight recorded and transmitted to the weigh indicator. When the container is full or has received its complement of waste oil, the final weight of the container is measured and transmitted to the weigh indicator. If further waste oil is needed to be transferred, the initial container can be easily removed on site and a fresh empty container inserted once again into the container receiving structure.

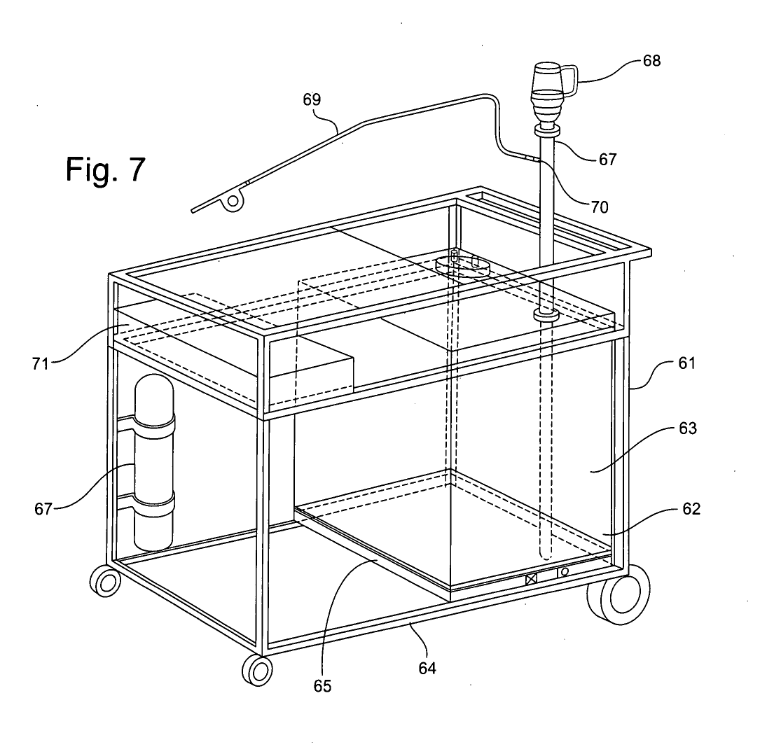

Referring to FIG. 7, there is shown a further embodiment of the present invention in which the portable material transfer unit 1 includes a wheeled frame 2 having two support stations 30a and 30b spaced apart for removably receiving a cartridge 31. The support stations 30a and 30b effectively separate the wheeled frame into two compartments for housing two containers. The support stations define a recess portion immediately beneath the container compartments, which slidably receive a cartridge 32. The cartridge 32 includes a built-in weigh pan so that when in position within a support station, a container is seated on the weigh pan so that the volume/amount of oil or fat compositions transferred to or from an external storage means can be continuously monitored by change in container weight. The multiple support stations allows repositioning of the invention the cartridge so that a first container can be supported on the portable/wheeled frame in a first compartment and a second and further container can be operably located in a second and further compartment in the frame in a stackable array, and the cartridge can be relocated and operated from a programmable control.

FIG. 7 further shows that the container(s) used in the present system can include a vacuum pump 33. In operation, the vacuum pump draws a vacuum from the container and allows transfer of a known volume of contents from the container to an external storage unit 34 or directly into a cooking vat or to a waste container.

In a further embodiment of the invention (not shown), the portable unit can include a pre-mixing station wherein the pre-mixing station is provided with (i) storage means for separately storing two or more different oils for cooking, and (ii) an oil distribution means interconnected to the storage means, wherein the distribution means meters out a predetermined volume of an oil or selection of two or more oils.

Referring to FIG. 7 there is shown a portable material transfer unit 30 in accordance with the present invention. The unit 30 includes a mobile container 31 which comprises a tank 32 mounted on a wheeled base frame 33. The unit further comprises a weigh cartridge 34 which includes a weigh pan (not shown). FIG. 7 shows the weigh cartridge engaged in a mounting portion located beneath the tank. In operation, the weigh pan is connected to a weigh indicator which is calibrated to determine the amount of material transferred from the tank.

In FIG. 7 the weigh cartridge is securely seated on a section of the wheeled base frame. The weigh cartridge includes air operated hydraulic rams 35 (best seen in FIGS. 12a and 12b) which are connected to the weigh pan so that in an operating condition the hydraulic rams can lift the weigh pan relative to the weigh cartridge to both engage the container and lift the tank to perform weighing measurements.

The unit in FIG. 7 is also shown having a compressed air cylinder 36 mounted on the wheeled frame, which provides a source of compressed air to operate the hydraulic rams.

The tank 31 provides an opening for sealed insertion of a pump 37, the pump 37 having a removable motor 38. The pump is shown having a tap 39 extending from a removable tap connection 40, which acts as a conduit for transferring material under vacuum from the container to a kitchen apparatus such as a fryer (not shown) or an existing storage vessel/tank (best seen in FIG. 3).

The unit of FIG. 1 further includes a controller 41 slidably mounted to the wheeled frame so that when not in operation, the controller can be withdrawn into a cavity within the frame. The controller can be an electronic wireless device which receives data from the weigh pan. The controller can include a wireless data transfer facility, and can be connected to a personal computer with an inbuilt scanner with a signal to operate.

The controller is operatively connected wirelessly to a supply station (not shown) upstream therefrom. The controller can pre-programme the supply station to supply a desired material or blend of materials including fats to the unit.

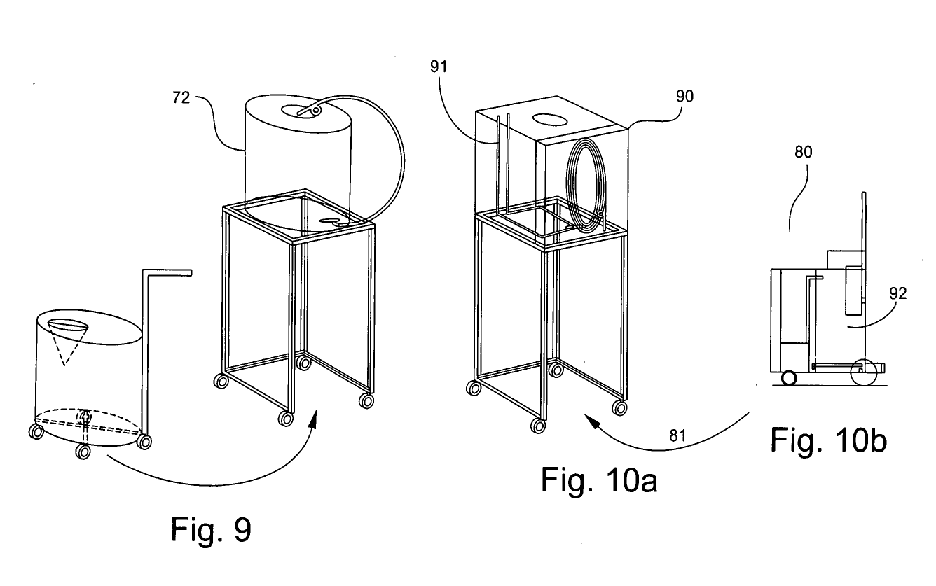

In an operating condition the tank 31 is supplied with a volume of material from the supply station. The unit is transported to a kitchen apparatus (not shown) or an existing storage vessel (refer FIG. 9). In FIG. 9, the unit 30 is wheeled to a location immediately below an elevated storage tank 42. Once in position, the hydraulic rams lift the weigh pan to positively engage the tank 31 so that the total weight of the tank and contents can be weighed. The pump 37 then enables transfer of the material from the tank 31 to the storage vessel 42 or directly to a fryer (not shown), and the actual amount of material transferred is determined by the weigh indicator on a weight differential calibration.

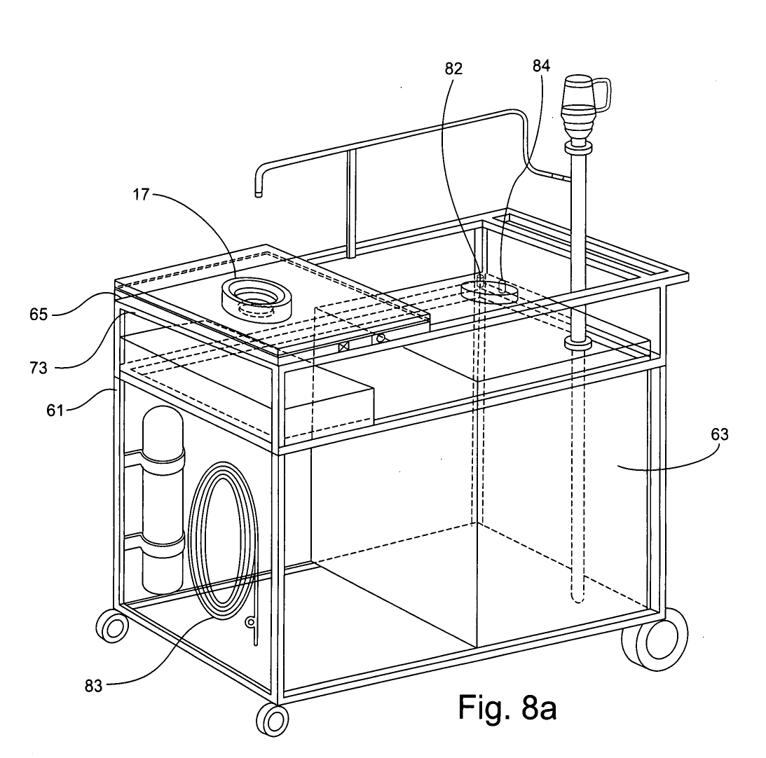

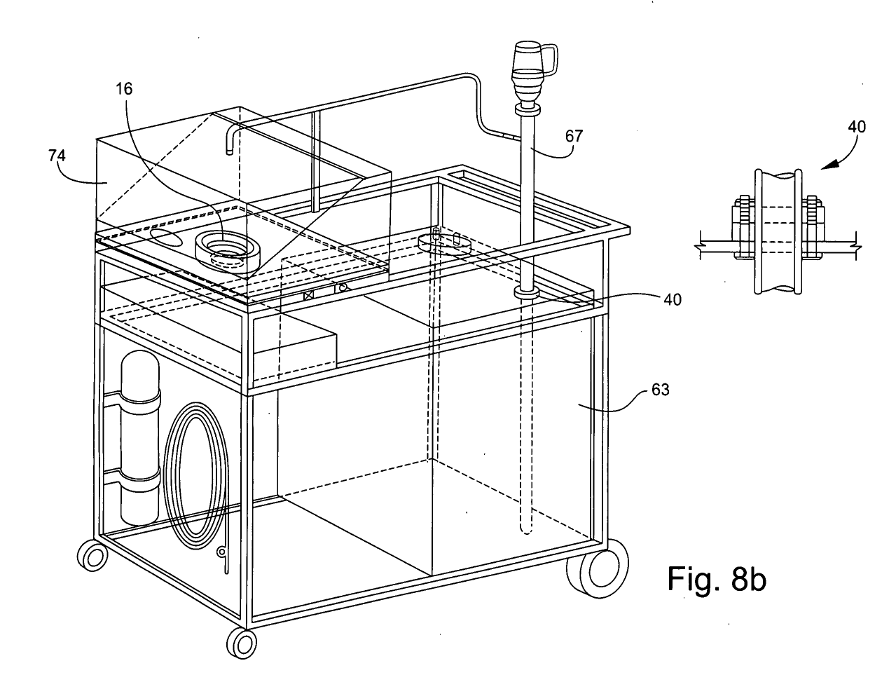

Referring to FIGS. 8a and 8b, there is shown an embodiment of FIG. 7 illustrating the unit having the weigh cartridge 65 mounted on a second mounting portion 73 of the frame above the container 63. In this position, the mobile unit can receive a packaging container 74, which can be filled with oil from the container 63 by actuating the pump 67. One significant advantage of this is that a packaging container 74 can be pre-filled in a controlled environment.

In this embodiment, the portable transfer unit includes a packing base 16 positioned on the weigh cartridge on a top support portion of the frame 61. The packing base includes a container receiving structure 17 having a series of internal shoulders in stepped apart relation for receiving containers of varying sizes.

Turning to FIGS. 10a to 10c, there is shown a further embodiment showing a transportable material transfer unit 80 for receiving waste material from a kitchen apparatus such as a fryer or a waste storage tank (not shown). In this embodiment the unit 80 includes a vacuum pump 81 in a separate compartment of the frame.

In operation the vacuum pump 81 is connected to an inlet port 82 on the container and creates a vacuum within the air space of the container. A hose 83 is extended between the container 63 and the waste storage vessel or fryer, and the vacuum urges transfer of waste oil to the container. As waste material is transferred to the container, the weigh pan, located at a mounting portion beneath the container, engages the container so that weight measurements can be obtained hence the weight of waste material can be determined.

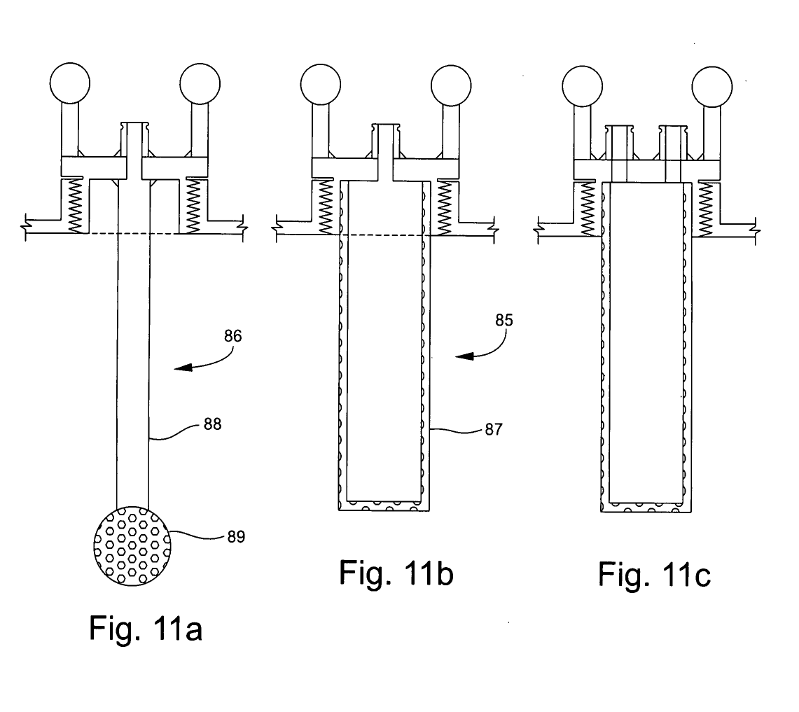

As shown, the mobile container can further include a second inlet port 84 adapted to fit a filter element 85 (refer FIG. 11b) and a washing element 86 (refer FIG. 11a). The filter element can include an oil filter medium 87 through which cooking material oils and/or fats pass.

The washing element 86 can include a hollow body 88 on the end of which there is mounted a spray head 89 wherein when fitted to the inlet port 84, the body and spray head reside within the internal compartment of the mobile container wherein the body and spray head are in fluid communication and the body is connectable to an external fluid source.

Referring to FIG. 10a, there is shown a storage vessel 90 for storing a volume of liquefied fats by means of heating element 91. In this embodiment the storage vessel can be used to replenish a kitchen apparatus directly by gravity feed. FIG. 10a shows the unit 80 being transported to the storage vessel so that the amount of material used to replenish a fryer can be measured.

The unit 80, with weigh cartridge located beneath the container in a first mounting portion, can be wheeled beneath the storage vessel and the hydraulic rams operated to force engagement between the weigh pan and bottom surface of the container 92. The rams can be further engaged to lift the unit into engagement with the storage vessel 90 hence the total weight of the unit 80 plus the storage vessel 90 can be lifted for weighing. As material is fed from the storage vessel to replenish a fryer, the amount of material remaining in the storage vessel is weighed and the actual amount of material transferred determined on a differential basis.

As understood, an alternative means of weighing the amount of material transferred from the storage vessel can be determined by relocating the weigh cartridge to a second mounting portion above the container on or close to the top surface of the frame. It is also understood that the wheeled frame or mobile container can include a first and second mounting portions so that the weigh cartridge can be relocated from one mounting portion to another depending on the operation.

In this position the rams can be actuated to cause the weigh pan to engage the storage vessel, and an initial weight measurement taken. The final weight of the storage vessel can then be weighed once a sufficient amount of material has been transferred, and the actual amount of material transferred calculated.

In a further embodiment of the invention (not shown), there is provided a material transfer system which is portable for receiving or transferring a measurable quantity of a solid and liquid material or combinations thereof such as cooking oil and fats, the system including: a mobile supply station having one or more vessels for supply or receiving an amount of a material or mixture of material, the one or more vessels being interconnected to a pumping means to transfer a material or mixtures of materials, the pumping means being operable by a controller to provide a measured amount of material or mixture of materials from the one or more vessels; and a transportable material transfer unit moveable between the supply station and a material storage tank or cooking vat including: at least one mobile container, the container having an internal compartment for receiving a quantity of material or mixture of materials from the supply station, a controller operatively connected to the supply station, a pump means supported by the container for transferring material from the internal compartment to a vat or other storage or packaging means, a weigh cartridge including a weigh pan, the weigh pan being operably connectable to the controller, at least one mounting portion adjacent to or on the mobile container for removably receiving the weigh cartridge, whereby the weigh pan is connected to a weigh indicator which is calibrated to determine the amount of material transferred from or received by the container, wherein upon receiving or transferring of material or combinations of material, the change in weight of the container is measured by the weigh pan and the actual amount of material transferred is determined by the weigh indicator on a weight differential calibration.

The system of the invention can include a blending station intermediate the supply station and the transportable material transfer unit, wherein the one or more vessels is/are separately interconnected to the blending station by a series of pump means, and wherein the controller controls the series of pump means to provide a desired material or combination of materials to the transfer unit.

In this embodiment of the invention, the blending station can be located above the level of the mobile container so that material at the blending station can be fed to the container by gravity feed. In a further embodiment, the blending station can include a series of inlet ports so that each vessel at the supply station can be provided with a dedicated pump line to a separate inlet port. In this embodiment the blending station is a common vessel, and the use of dedicated pump lines substantially avoids any possibility of cross contamination of different materials.

One or more of the vessels at the supply station can include a heating element so that a supply of a cooking fat or fats can be maintained at a temperature so as to provide the fat or fats in a liquefied form.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

1. A material transfer unit moveable between a supply station and a material storage tank or cooking vat including:
a mobile container adapted for receiving a quantity of material or mixture of materials from the supply station, the mobile container having at least one receptacle mounted to a wheeled support frame wherein the support frame includes a top and bottom frame ends and wherein the bottom end includes a wheeled base and a first weigh cartridge location between the base and the at least one receptacle;
a controller operatively connected to the supply station;
a pump means supported by the mobile container for transferring material from the at least one receptacle to a vat or other storage or packaging means;
a weigh cartridge including a weigh pan, the weigh pan being operably connectable to the controller, wherein in an operating condition the weigh cartridge is removably received within the first weigh cartridge location between the base and the receptacle in a first weigh condition, whereby the weigh pan is connected to a weigh indicator which is calibrated to determine the amount of material supplied to the at least one receptacle by the supply station and/or amount of material dispensed from the receptacle to a vat; and
wherein upon receiving or transferring of material, the change in weight of the mobile container is measured by the weigh pan and the actual amount of material transferred is determined by the weigh indicator on a weight differential calibration.

2. The material transfer unit which is portable for receiving or transferring a measurable quantity of a solid and liquid material or combinations thereof in accordance with claim 1 wherein the at least one receptacle of the mobile container can include a heating element, which can be used to maintain a supply of a cooking fat, otherwise solid at ambient temperature, in a liquefied state.

3. The material transfer unit which is portable for receiving or transferring a measurable quantity of a solid and liquid material or combinations thereof in accordance with claim 1 wherein the mobile container includes a second weigh cartridge location at or adjacent to a top portion of the at least one receptacle for removably receiving the weigh cartridge in a second weigh condition so that the weigh cartridge can be relocated from one location to the other allowing weigh calculation of the at least one receptacle and a second receptacle stacked on top of the at least one receptacle.

4. The material transfer unit which is portable for receiving or transferring a measurable quantity of a solid and liquid material or combinations thereof in accordance with claim 1 wherein the pump means includes a removable tap interconnected thereto so that cooking material drawn from the internal compartment under vacuum and directed by the tap to another vessel or directly into a kitchen apparatus such as a fryer.

5. The material transfer unit which is portable for receiving or transferring a measurable quantity of a solid and liquid material or combinations thereof in accordance with claim 1 wherein the mobile unit further includes a vacuum pump mounted by the mobile container, and a material transfer pipe extendable between a frying vat and the at least one receptacle for transfer of waste from the frying vat, whereby in operation the vacuum pump creates a vacuum in the air space of the at least one receptacle of the mobile container wherein the vacuum allows transfer of contents from the vat to the at least one receptacle as waste via the transfer pipe.

6. The material transfer unit which is portable for receiving or transferring a measurable quantity of a solid and liquid material or combinations thereof in accordance with claim 1 wherein the mobile container further includes an inlet port adapted to fit a filter element and a washing element.

7. The material transfer unit which is portable for receiving or transferring a measurable quantity of a solid and liquid material or combinations thereof in accordance with claim 1 wherein the controller is programmed to operate the supply station such that the supply station can supply a preselected material or mixture of materials including cooking oils and/or fats.

8. The material transfer unit which is portable for receiving or transferring a measurable quantity of a solid and liquid material or combinations thereof in accordance with claim 1 wherein the weigh cartridge further includes a lifting means to assist lifting the unit or the at least one mobile container.

9. The material transfer unit which is portable in accordance with claim 1 wherein the mobile container can include a further compartment adjacent the at least one receptacle for housing a vacuum pump and/or compressed air cylinder.

10. The material transfer unit which is portable in accordance with claim 1 wherein the support frame can also include a recess in the top frame end to removably receive the weigh cartridge in a second weigh condition such that a storage vessel or packaging container or second receptacle can be located above the first receptacle and weighed by the weigh pan.

11. A process for packaging a supply of oil, the process including:
providing a material transfer unit moveable between a supply station and a material storage tank or cooking vat and the like, the unit including:
a container adapted to be transportable, the container having an internal compartment for receiving a quantity of material or mixture of materials from the supply station,
a controller operatively connected to the supply station for controlling a supply of a material or mixture of materials from the supply station to the container,
a pump means supported by the internal compartment of the container for transferring material from the internal compartment to a packaging container,
a weigh cartridge including a weigh pan, the weigh pan being operably connectable to the controller, whereby the weigh pan is connected to a weigh indicator which is calibrated to determine the amount of material transferred from or received by the container;
a lifting means mounted by the weigh cartridge, the lifting means being operable to urge positive engagement between the weigh pan and the packaging container so that the packaging container can be lifted and weighed;
a mounting portion located above the internal compartment of the mobile container for removably engaging the weigh cartridge in a first mounting position above the mobile container;
wherein a packaging container is placed on the weigh cartridge and the weigh pan is positively urged against the mobile container, and wherein the pump means transfers a supply of material from the mobile container to the packaging container, and the change in weight of the packaging container is measured by the weigh pan and the actual amount of material transferred is determined by the weigh indicator on a weight differential calibration.

12. The process for packaging a supply of oil according to claim 11 wherein the mobile transfer unit further includes a packaging container receptacle mounted on the weigh pan for receiving the packaging container or a storage vessel.

13. The process for packaging a supply of oil according to claim 12 wherein the packaging or container receptacle includes a series of discrete stackable bodies for receiving packaging containers of varying sizes wherein the stackable bodies include a seat for receiving a base portion of a corresponding sized container and a shoulder for receiving the seat of a second mounting body in a demountable stackable array.

14. The process for packaging a supply of oil according to claim 13 wherein the stackable bodies forming the container receptacle structure include co-operating mounting means so that a plurality of bodies can be readily stacked or separated from one another.

15. A material transfer unit moveable between a supply station and a material storage tank or cooking vat including:
a mobile container adapted to receive a quantity of a material or mixture of materials from the supply station, the mobile container having at least one receptacle mounted to a wheeled support frame wherein the support frame includes a top and bottom frame ends and wherein the bottom end includes a wheeled base and a first weigh cartridge location between the base and the receptacle;
a controller operatively connected to the supply station;
a pump means supported by the mobile container for transferring material from the receptacle to a vat or other storage or packaging means,
a weigh cartridge including a weigh pan, the weigh pan being operably connectable to the controller, wherein in an operating condition the weigh cartridge is removably received within the first weigh cartridge location between the base and the receptacle in a first weigh condition, whereby the weigh pan is connected to a weigh indicator which is calibrated to determine the amount of material supplied to the at least one receptacle by the supply station and/or amount of material dispensed from the receptacle to a vat, wherein upon receiving or transferring of material, the change in weight of the at least one receptacle is measured by the weigh pan and the actual amount of material transferred is determined by the weigh indicator on a weight differential calibration; and
wherein the mobile container includes a second weigh cartridge location adjacent to or located on an upper portion of the mobile container for removably receiving the weigh cartridge in a second weighing condition in which a second and subsequent receptacle can be mounted in a stackable array.

16. The material transfer unit which is portable for receiving or transferring a measurable quantity of a solid and liquid material or combinations thereof in accordance with claim 15 further including a heating element within the receptacle, which is operable to maintain a supply of a solid cooking fat at ambient temperature, in a liquefied state.

17. The material transfer unit which is portable for receiving or transferring a measurable quantity of a solid and liquid material or combinations thereof in accordance with claim 15 wherein when the weigh cartridge is removably received within the first weigh cartridge location, the receptacle is seated on or adjacent to the weigh pan.

18. The material transfer unit which is portable for receiving or transferring a measurable quantity of a solid and/or liquid material or combinations thereof in accordance with claim 15 wherein the mobile container includes a plurality of receptacles mounted in a stackable array wherein the weigh cartridge is relocatable from the first weigh cartridge location to a second and subsequent weigh cartridge locations between adjacent receptacles for weighing contents of each receptacle in the array.

19. The material transfer unit which is portable for receiving or transferring a measurable quantity of a solid and liquid material or combinations thereof in accordance with claim 15 wherein the mobile unit further includes a vacuum pump mounted by the mobile container, and a material transfer pipe extendable between a frying vat and the receptacle for transfer of waste from the frying vat, whereby in operation the vacuum pump creates a vacuum in the air space of the receptacle wherein the vacuum allows transfer of contents from the vat to the receptacle as waste via the transfer pipe.

20. The material transfer unit which is portable for receiving or transferring a measurable quantity of a solid and liquid material or combinations thereof in accordance with claim 15 wherein the controller is programmed to operate the supply station such that the supply station can supply a preselected material or mixture of materials including cooking oils and/or fats.
